(19) United States
(12) Patent Application Publication
(10) Pub. No.: US 2023/0235776 A1
(43) Pub. Date: Jul. 27, 2023

(54) SYSTEMS AND METHODS FOR A LOCKING CARABINER

(71) Applicant: Peter Grossman, CASTLE HILL (AU)

(72) Inventor: Peter Grossman, CASTLE HILL (AU)

(21) Appl. No.: 17/584,402

(22) Filed: Jan. 26, 2022

(51) Int. Cl. F16B 45/02

(52) U.S. Cl. CPC F16B 45/028; F16B 45/024

(57) ABSTRACT

A locking carabiner system and methods comprising a frame, gates and a gate biasing apparatus that includes a wire formed gate pivotably attached to the carabiner frame which can be rotated between two positions with movement from either position to the other position opposed by a biasing force, such force undergoing a change in the direction of bias as the gate is pivoted from one position to the other position resulting in two separate and distinct stable gate positions. Among other uses, such a gate can form a locking mechanism when in a first position it obstructs other gates from operating until it is rotated to the second position. The inventive locking mechanism can be incorporated into carabiners and other attachment devices to prevent the accidental opening of gates and to ensure that attached ropes, keys and other articles remain secured.

### FIELD OF THE INVENTION

This invention relates generally to a carabiner. More particularly, some implementations of the present invention relate to systems and methods for providing a carabiner having one or two enclosures that are selectably openable and closable with a mechanism to lock and unlock such access to the enclosures.

### BACKGROUND OF THE INVENTION

For many years, carabiners have been an integral tool used in a wide variety of rope intensive activities including mountaineering, construction, arboriculture and sports. Such activities use one or more carabiners to retain ropes in desired positions with respect to a user, allowing a relatively easy and quick attachment or release to the rope. Carabiners are also used to attach climbing apparatus and other objects to a climber’s body harness and other attachment points.

Over time, carabiners have also become integrated into everyday use as a convenient method of releasably coupling articles such as key rings and various tools to one another due to the ease and speed with which such articles can be attached and removed from the device. Additionally, the carabiner itself can be quickly and easily attached to or detached from a belt loop, a bag strap or other articles thus providing a convenient way to carry numerous objects.

While the specific characteristics and components of carabiners can vary greatly a commonly formed carabiner is comprised of a rigid frame incorporating one or more gates and a releasable gate closure mechanism. The gate is configured to releasably engage the frame so as to form a continuous inner region which can mechanically couple to one or more objects. The releasable gate closure mechanism is configured to allow the gate to be selectably pivoted with respect to the frame to facilitate addition or removal of items from the continuous inner region. The releasable gate closure mechanism simultaneously biases the gate toward a closed configuration with respect to the frame so as to maintain mechanical coupling of items within the continuous inner region. A wide variety of frames, gates, and biasing systems exist to specifically accommodate particular applications and/or manufacturing costs for the carabiner.

Although the gates are generally biased by various means to remain in the closed position to ensure that the retained articles remain securely attached to the carabiner, at times the gate or gates on a carabiner may inadvertently be moved to an open position by occurrences during movement or by the movements of the articles attached to the carabiner resulting in the detachment of the articles from the carabiner. This detachment or loss is undesirable.

Many methods have been devised over time to selectably prevent carabiner gates from inadvertently opening, with such locking methods varying in complexity and functionality.

Wire gates have been very commonly made over many years and are generally formed from a single length of elastically deformable material such as spring wire into an elongated U-shaped open loop with two long arms joined by a short arm at the head of the loop. A short length of each of the ends of the long arms are bent towards each other to create two opposing pivot arms that are not co-axial and are inserted into two corresponding apertures positioned in the carabiner frame. The lengthwise ends of the wire gate are oppositely and non-coaxially coupled to the frame such that, as the gate is selectably rotated about the frame coupling points, the different axis of rotation of each of the long arms creates a distortion that combines with the spring/rebound rigidity of the gate to create an automatic biasing mechanism that resists the distortion returning the gate to a non-distorted configuration once the rotating force is removed.

Such wire gates are commonly used as the primary carabiner gate securing the continuous inner region of a carabiner and have also been used as a second gate to selectably prevent the primary gate from inadvertently moving to an open position in different ways. The biasing forces inherent in the commonly used design of wire gates and pivoting configurations automatically moves such gates back to a single undistorted position once the force that is applied to rotate the gates away from the undistorted position is removed, requiring the need for often complex and simultaneous actions on multiple parts to allow access to the inner region. Such gates often limit the function of the primary gate as they must always be moved before the primary gate can be opened or closed.

It would be very desirable to have a method of locking or securing a carabiner gate that did not require an assembly of several moving often complex parts which could become inoperable under freezing conditions or when filled with dirt or snow. It would be very desirable to have a method of locking or securing a carabiner gate using a single moving part able to be positioned using the fingers of only one hand and which when not in the locking position would remain in a position that did not interfere with the unlocked operation of the carabiner.

### BRIEF SUMMARY OF THE INVENTION

Carabiners typically include a frame of rigid material in the form of an incomplete loop generally in a C-shape including a first end and a second end located on opposite sides of an opening. A primary gate is pivotably coupled or hinged to the first end of the frame with the free end of the primary gate in contact with the second end of the frame to form a continuously enclosed inner region when in a closed configuration. The free end of the gate is rotatable about a first axis perpendicular to a plane that bisects the C-shaped body. The gate is considered to be in a closed position when the free end is in contact with the second end of the frame and in an open position when the free end is rotated into the inner region away from the second end of the frame.

A gate closure mechanism generally biases the gate toward a closed configuration so that the free end of the gate remains in contact with the frame to maintain a continuous inner region. A force must then be applied to rotate the gate away from the frame to form an open position to allow articles to be moved into and out of the carabiner. Such a force must usually be continuously applied to hold the gate in the open position, and once this force is removed the gate will return to the closed position with respect to the frame. A wide variety of frames, gates and biasing systems exist and are configured in a wide variety of frame and gate shapes.

The present invention, in a number of embodiments, includes a carabiner having two gates, one of which is elastically deformable and has two selectable positions, one of which blocks the other gate from rotating. Although the preferred configuration is an inner gate that selectably blocks an outer gate from being inadvertently being pushed to an open position, in other embodiments it can be seen that an inner gate can be protected by an elastically deformable outer gate with two selectable positions, one of which protects the inner gate from being inadvertently being pushed to an open position and one of which urges the gate against the frame in a configuration that then allows the inner gate to function as an unimpeded outer gate.

A first embodiment of the present invention relates to a gate formed from an elastically deformable material, the preferred embodiment being spring wire, with two selectable positions where, in both positions, all torsional biasing forces acting on the gate are equally balanced. Such a two-positioned gate can be selectably rotated from either position to the other position by the application of a force such as applied by a finger, and will remain in the selected position once the force is removed and until another rotating force is applied.

Said wire gate is constructed from a single length of spring wire formed into an elongated U-shaped loop with two long arms of unequal length separated by a short arm at the head of the loop. A short length of the ends of the both long arms are bent towards each other to create two opposing pivot arms that are not co-axial and are able to be inserted into two corresponding apertures positioned in the carabiner frame to enable the free end of the gate to be rotatable about a first axis perpendicular to a plane that bisects the carabiner frame. The lengths and relative angles of the long arms of the gate and the positioning of associated apertures in the frame into which the short pivot arms are inserted constitute the gate assembly.

The present invention teaches a configuration of a gate and gate assembly that, when the correctly configured gate is oppositely and non-coaxially coupled to the frame, two gate positions are created within the arc of rotation of the gate where all torsional biasing forces acting on the gate are equally balanced. In particular, applying a force to rotate either free end of the gate from one position to the other position results in a distortion that creates an automatic torsional biasing mechanism that resists the distortion until the gate has pivoted approximately halfway to the other position, upon which point the direction of the distorting bias is reversed. The reversal in direction of the distorting bias and existence of two positions along the path of the gate rotation allows the construction of a two-position wire gate wherein either position can be selectably chosen as desired.

The present invention teaches the method to configure an elastically deformable carabiner gate with two selectable positions, the method to determine the distance between the two positions along the path of rotation of the aforesaid gate and a method to adjust the strength of the biasing force resisting the rotation between the two selectable positions.

The present invention further teaches how to apply the aforesaid carabiner gate to secure carabiners and other attachment devices from being inadvertently

A first embodiment of the present invention is a locking carabiner with two gates: a primary external gate coupled to the carabiner frame to form a continuous inner region in the closed position and a second internal wire gate located within the continuously enclosed inner region of the carabiner configured to have a directionally changing torsional biasing force and able to be selectably rotated between a first locking position and a second unlocked position. The second gate provides a blocking mechanism in the locking position that prevents the primary gate from rotating and inadvertently moving from a closed to an open position while also dividing the inner continuous region into two separate regions, both able to contain separate articles or attachments. Rotating the second inner gate to the selectable unlocked position removes the blocking action on the primary gate while allowing the two inner regions to combine into one inner region. When the inner gate is in the unlocked position it will remain torsionally biased against the carabiner frame allowing the primary gate to be freely rotated into an open or closed position and articles and attachments to be moved into and out of the inner region as required and moved to any portion of the inner frame as needed.

By modifying the configuration in the manner taught the locations of the neutral non-distorting positions of the wire gates can be deliberately determined as can the strength of the biasing forces.

It will be evident to those skilled in the art that the disclosed configuration of an elastically deformable two position gate is independent of the shape of the gate and that the gate shape can be varied without affecting the strength or the change in direction of biasing forces caused by torsional changes in the gate.

Such locking gates are simple and inexpensive to manufacture and assemble. They are easy to use and can be pivoted between a locking or unlocking position by the use of the fingers of one hand. Freezing conditions or the presence of snow or debris would have little, if any, effect on their function.

Those skilled in the art will appreciate that the described systems and methods can be used in a variety of different applications and in a variety of different areas of manufacture. For instance, in some implementations, the described systems and methods can be configured to be used to provide lockable carabiners that are manufactured and tested for load-bearing in safety critical conditions, such as for use in mountain and rock climbing. In other implementations the described systems and methods can configured to be used to provide lockable snap hooks for lighter duties of attaching articles.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWING

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular, rather than complete, portions of the systems and methods of making and using the system according to the invention. In the Figures, the physical dimensions may be exaggerated for clarity.

FIG. 1 illustrates the pivot points and pathways/arcs and biasing forces of a typical elastically deformable carabiner wire gate describing the existence of only one neutral position;

FIG. 1A illustrates a front view of an embodiment of a gate described in FIG. 1;

FIG. 1B illustrates a rear view of the gate described in FIG. 1A;

FIG. 1C illustrates a front top view of the gate described in FIG. 1A;

FIG. 1D illustrates a rear top view of the gate described in FIG. 1A;

FIG. 2 illustrates the pivot points and pathways/arcs and biasing forces of an elastically deformable carabiner wire gate showing a first position and rotation to a second position, describing the existence of two neutral positions in accordance with the principles of the present invention;

FIG. 2A is a front view of one embodiment of a locking carabiner showing the locking gate described in FIG. 2 in a locked and unlocked position in accordance with the principles of the present invention;

FIG. 3A illustrates a front view of an embodiment of a gate described in FIG. 2A in accordance with the principles of the present invention;

FIG. 3B illustrates a front top view the gate described in FIG. 3A;

FIG. 3C illustrates a rear top view the gate described in FIG. 3A;

FIG. 3D illustrates a rear view of the gate described in FIG. 3A;

FIG. 3E illustrates a left side view the gate described in FIG. 3A;

FIG. 3F illustrates a right side view of the gate described in FIG. 3A;

FIG. 4A is a front view of one embodiment of a locking carabiner in a closed and locked position in accordance with the principles of the present invention;

FIG. 4B is a front view of the locking carabiner shown FIG. 4A in an unlocked and closed position;

FIG. 4C is a front view of the locking carabiner shown FIG. 4A in an unlocked and open position;

### DETAILED DESCRIPTION OF THE INVENTION

The present invention, in a number of embodiments, relates to mechanical coupling mechanisms such as carabiners and snap-hooks and an improved wire gate system including a frame, gate, and gate biasing system. The gate may be referred to as a wire-type gate in that it includes an arch and two ends in several embodiments. The two ends are pivotably coupled to the frame at two independent gate coupling points so as to utilize the torsional rigidity of the gate structure as the gate is pivoted with respect to the frame. The inherent torsional rigidity and/or composition properties of the gate generates a rebound or spring response force which resists the distortion being forced on the gate structure and which biases/pivots the gate back toward the configuration of least distortion.

In common usage such biasing systems urge towards only one direction, returning the gate to one configured position to which it returns automatically.

As defined in the present invention “wire” is an elongated structure having two lengthwise ends and a particular cross-sectional shape. The term wire may broadly include various compositions such as metal and cross-sectional shapes such as circular. The wire may also be bent into a particular lengthwise shape or configuration including particular curvatures. For example, a bent “arch” or “loop” region may include a curved region of more than ninety degrees.

The term “lengthwise” is understood to be an orientation for measurement referring to the longest dimension of a mechanical component.

The term “distortion” means the deformation of an elastically deformable rigid structure such as a wire gate causing the structure to stretch. When released the distorted structure will return to the unstretched and undistorted configuration which, for the purposes of the present invention is termed a “neutral position”.

The urging of the structure toward the undistorted configuration is termed a “bias” and the urging forces involved are understood to be “biasing forces”.

A “gate biasing system” is understood to be a system of components configured to bias the gate of a carabiner toward a particular configuration.

As defined in the present invention “pivotable” means that two components are coupled or ‘hinged’ together in a “pivotably coupled” manner that facilitates a pivot type movement between them. To pivotably couple a wire gate to a frame, portions of the free ends of the wire gate are bent perpendicularly and inserted into and engaged with holes, termed “apertures”, positioned in the frame.

The arch or loop end of a wire gate is understood to be the “free end” as are the lengthwise portions of the wire gate adjacent to, and bent into, the arch or loop.

The opposite end is termed the pivot end or pivot region where the lengthwise portions of the wire gate are bent to form the pivot arms that engage and pivotably couple with the frame apertures and the frame.

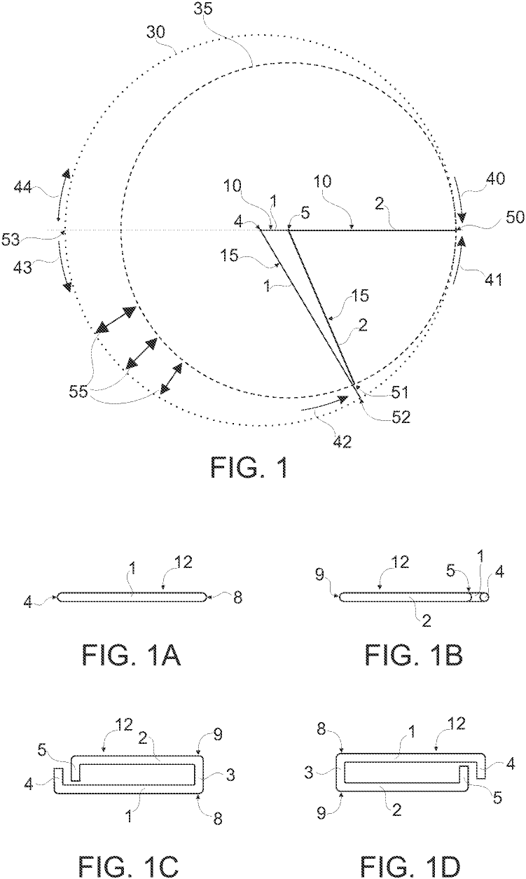

Reference is initially made to FIGS. 1A -1D, which illustrate the structure of a commonly shaped wire gate 12. Reference is also made to FIG. 1, which separately pictorially illustrates the distortions forced on the gate arms 1, 2, 3 as the gate 12 is rotated when pivotably coupled to a carabiner frame, and the directions and relative strengths of the biasing forces generated by the distortions.

A carabiner frame (not illustrated) is generally in the form of a C-shape body having a top section and a bottom section connected on one side by a continuation of the frame and having a gap on the other side, with an upper frame end and a lower frame end on either side of the gap. A wire gate 12 can be pivotably connected 4, 5 to either frame end but most commonly to the bottom end and is then configured so that the free end 3 of the gate comes into contact with the opposite frame end creating a continuous inner region in what is generally called a closed position. When the wire gate end 3 is rotated away from the frame to an open position the gate becomes distorted and biasing forces 41, 42 are generated automatically moving the gate back to a closed position.

The wire gate 12 is formed from a continuous length of spring wire comprising a loop end 3 bent to form two separate lengthwise arms 1, 2 of dissimilar lengths being parallel and lying substantially in the same plane with the pivot arms 4, 5 of the lengthwise arms 1, 2 bent perpendicularly and non-coaxially towards each other substantially in the same plane as the loop end 3 to form two opposing pivot arms 4, 5. The pivoting arms 4, 5 are inserted into apertures in the carabiner frame (not illustrated) and allow the gate 12 to rotate from a resting position 50 in which the gate 12 is not distorted and no resultant biasing forces have been generated. The pivoting end 4, 5 of the gate 12 is described as hinged or coupled and forms a pivot assembly 4, 5 around which the loop end 3, 8, 9, generally called the free end of the gate, is able to rotate, describing a roughly circular path 30, 35.

FIGS. 1 - 1D illustrate that wire gates used in carabiners are configured to have only one neutral position, being the only position where the gate is not distorted and not subject to bias. Rotating such a gate to any other position requires the continual application of a force to prevent the wire gate returning to the only neutral position.

FIG. 1 pictorially describes the distortions and biasing forces 41, 42 acting on the wire gate 12 and the gate arms 1, 2, 3 as the gate is rotated around the pivot arms 4, 5 when coupled to a carabiner frame, with the gate 12 to be viewed in a plane that would bisect the body of a carabiner frame as described in FIGS. 1A, 1B.

Pathway 30 describes the rotational path of the gate arm end 8 of the longer lengthwise gate arm 1 that forms part of the loop 3 of the gate 12 as it rotates around the pivot arm 4, and pathway 35 describes the rotational path of the gate arm end 9 of the shorter lengthwise gate arm 2 of gate 12 as it rotates around the pivot arm 5.

A first position 10 is described where the paths of rotation of both gate arm ends 8, 9 of the lengthwise arms 1, 2 of gate 12 intersect at the same point 50. When in this position 10 the wire gate 12 is undistorted and in a neutral state with any biasing forces 40, 41 from either rotational direction balanced. Gate 12 will remain at rest in this neutral position 10, 50 until a force is applied. The neutral position 10, 50 would generally be considered a closed position of gate 12, with the free end of the gate 3 substantially at rest or slightly biased against the frame of the carabiner.

FIG. 1 illustrates that the pathways 30, 35 describing the rotation of the gate arm ends 8, 9 of gate arms 1, 2 around the pivot arms 4, 5 only intersect at one position 10, 50 and that at all other points the wire gate 12 would be distorted and acted on by biasing forces resisting the rotation of the gate 12 away from the single neutral position 10, 50. It can be seen that as the wire gate 12 is rotated away from the neutral position 10, 50 the gate arm ends 8, 9 of the gate arms 1, 2 diverge from each other, such divergence increasing as the gate arm ends 8, 9 follow their respective rotational paths 30, 35.

A second position 15 illustrates the rotation of gate 12 to an open position such as would occur to allow access to the inner region of a carabiner. In the second position 15, both gate arm ends 8, 9 have moved from the same location 50 and orientation on their respective rotational paths 30, 35 of the first position 10 to different locations 51, 52, with the gate arm end 8 of the longer arm 1 positioned at a point 52 on path 30 and the gate arm end 9 of the shorter arm 2 positioned at a different point 51 on path 35. The change in locations 51, 52 and the relative orientation between the gate arm ends 8, 9 represents a distortion in gate 12 creating a biasing force 42 directed back towards the neutral position 10, 50. The further that gate 12 is rotated from the first position 10, 50 the greater the divergence of the gate arm ends 8, 9 from each other and the greater the distortions 55 and resisting biasing forces 42, 43 generated. At a point 53 along both rotational paths approximately 180 degrees from the first position 10, 50 the biasing force 43 will reverse in direction 44, 40 and continue to urge the gate to the first position 15, 50 from the new direction.

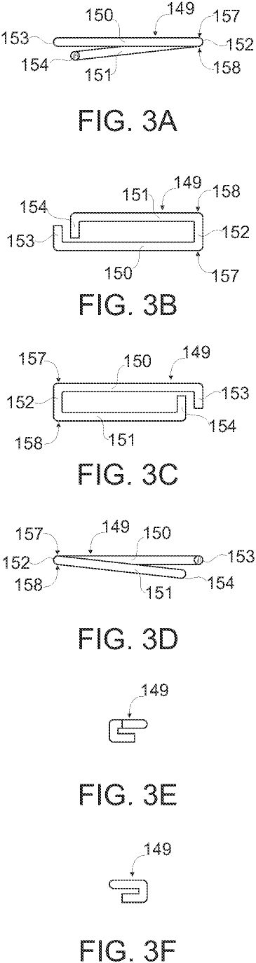

With reference to FIGS. 3A to 3F in a first embodiment according to the present invention a spring wire gate with two neutral positions is described.

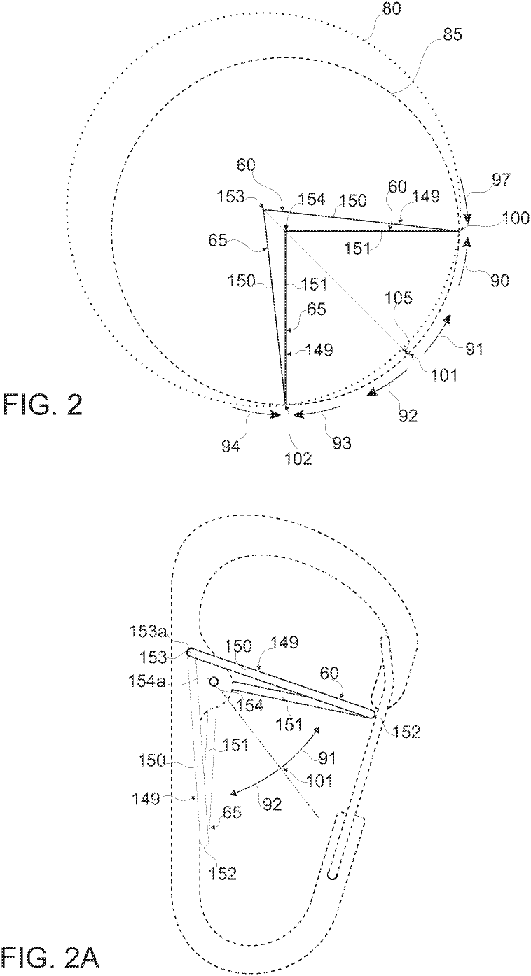

Reference is also made to FIG. 2, which separately pictorially illustrates the distortions acting on the gate arms 150, 151, 152 as the gate 149 is rotated when pivotably coupled to a carabiner frame, and the directions and relative strengths of the biasing forces generated by the distortions.

The wire gate 149 of the first embodiment of the present invention is formed from a continuous length of spring wire comprising a loop end 152 bent to form two separate lengthwise arms 150, 151 of dissimilar lengths being parallel and rotated away from the other both being perpendicular to the axis formed by the loop end 152. Short lengths of the ends of each arm 150, 151 are bent perpendicularly in opposing directions substantially toward the other to form pivot arms 153, 154 which are inserted into apertures 153a, 154a in a carabiner frame to form a pivot assembly around which the loop end 152, generally called the free end of the gate 149, is able to rotate.

The configuration of the gate biasing system of the present invention urges towards two different configured positions 60, 65 located along the circumference of travel 80, 85 with the configuration of the gate biasing system determined by the distances between and the relative positioning and orientation of the pivot arms 153, 154, the related apertures in the carabiner frame into which they insert 153a, 154a, the loop ends 152, and associated wire gate arm ends 157, 158 as disclosed herein.

FIG. 2A describes a wire gate 149 of the first embodiment of the present invention having straight arms 150, 151 as coupled to a carabiner frame so as to rotate between a first position termed a closed position 60 and a second position to be termed an open position 65. In both positions the wire gate 149 is undistorted and will remain in either selected position until a force is applied to rotate the gate 149 to the other position as desired.

The described gate can be pivotably coupled to any suitably shaped portion of a carabiner, snap-hook or attachment device frame including but not limited to projecting sections or joining sections of frame and can be positioned to rotate in any direction relative to such a frame as desired, whether coupled to act externally to an inner region relative to the frame or within an inner region relative to the frame.

Although the first embodiment describes the wire gate 149 of the present invention in a straight shape it will be obvious to those skilled in the art that the shape of the gate arms 150 and 151 can be curved, sinuous or of any shape that can be configured and biased as described.

Alternative embodiments may not be limited to spring wire, utilizing differing materials of elastically deformable materials of different composition.

While embodiments of the present invention are described in reference to wire-gate carabiners, it will be appreciated that the teachings of present invention are applicable to other areas including but not limited to non-wire gate carabiners, snap hooks and other attachment devices.

FIG. 2 pictorially describes the distortions and biasing forces acting on the wire gate 149 and the gate arms 150, 151, 152 as the gate is selectably rotated from an open to a closed position when coupled to a carabiner frame, with the gate 149 to be viewed in a plane that would bisect the body of a carabiner frame as described in FIGS. 3A, 3D.

Pathway 80 describes the rotational path of the gate arm end 157 of the longer lengthwise gate arm 150 that forms part of the loop 152 of the gate 149 as it rotates around the pivot arm 153, and pathway 85 describes the rotational path of the gate arm end 158 of the shorter lengthwise gate arm 151 of gate 149 as it rotates around the pivot arm 154.

A first closed position 60 is described where the paths of rotation of both gate arm ends 157, 158 of the lengthwise arms 150, 151 of gate 149 intersect at the same point 100. When in this position 60 the wire gate 149 is undistorted and in a neutral state with opposing biasing forces 90, 97 from either rotational direction balanced. The wire gate 149 will remain at rest in this neutral position 60 until a rotational force is applied, as would be the case if the gate 149 was rotated to the second open position 65.

Rotation of the gate 149 away from the first position 60 towards the second open position 65 causes an increasing distortion of the gate 149 and generates an opposing biasing force 90, 91 until the gate has rotated to a location roughly midway 101 towards the second position. At this location 101 the distortion and opposing biasing force reaches a maximum level 105 and the biasing force 91 reverses direction 92, urging the gate to rotate towards the second open position 65.

The second open position describes that the paths of rotation of both gate arm ends 157, 158 of the lengthwise gate arms 150, 151 of gate 149 intersect at the same point 102. In this position 65 the wire gate 149 is undistorted and in a neutral state with opposing biasing forces 93, 94 from either rotational direction balanced. The gate 149 will remain at rest in this neutral position 65 until a rotational force is applied, as would be the case if the gate 149 was rotated to back to the first closed position 60.

At all points along the path of rotation the gate is urged by biasing forces to the position of least distortion.

It is evident from a study of FIG. 2 that the distance between the two neutral positions 60, 65 can be controlled by changing the configuration of the gate biasing system, allowing the distance between the open and closed positions of the gate 149 to be determined as desired.

It can further be seen that the degree of distortion of the gate 149 and the resulting strength of the biasing forces 91, 92 towards the neutral positions can be varied as desired by changing the configuration of the gate biasing system.

It can be understood from the detailed description that the gate arms 150, 151 between the pivot arms 153, 154 and the loop end 152 illustrated as straight in FIGS. 2, 2A can be of different lengths and shapes to that shown without affecting the reversal of biasing forces 91, 92 and the balanced biasing forces 97, 90, 93, 94 in the two described neutral positions 100, 102.

As defined in the present invention a carabiner is a mechanical device including a frame, at least a gate, and an inner region defined between the frame and the at least one gate.

In another embodiment of the present invention a carabiner is provided including a frame 270 having a top section 271 and a bottom section 272 connected on one side by a continuation of the frame forming a spine 273 and on the other side having a first end 280 and a second end 275 opposite and substantially facing the first end 280 with a gap 285 between the ends 275 and 285, a first external gate 12 defining with the frame 270 an inner region 290 and a second internal gate 149 extending into the inner region 290.

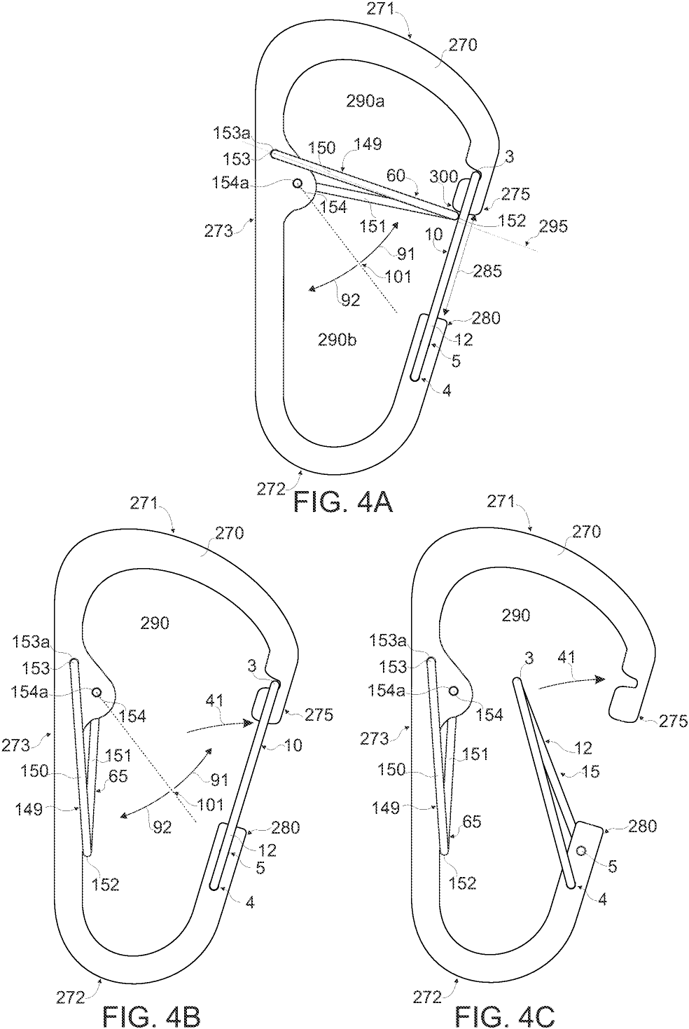

With reference to FIGS. 4A, 4B, 4C in an embodiment according to the present invention a lockable carabiner with two gates 12, 149 one being a spring wire gate with two selectable positions 149 which can selectably lock the other gate 12.

In particular, the carabiner 271 comprises a frame 270 partially enclosing an inner region 290 and having a first end 280 and a second end 275, and a first gate 12 as described in FIGS. 1, 1A to 1D pivotably coupled to the frame at said first end 280.

Reference is also made to FIGS. 1 to 1D which illustrate the directions of biasing forces acting on the said first wire gate 12 when in a closed position 10, when in an open position 15, and when selectably rotated from a closed 10 to an open position 15.

In detail, when in a first closed position 10 the loop end 3 of external gate 12 is biased 41 towards contact with the frame end 275, defining a continuous inner region 290 with respect to the frame 270 and external gate 12. In the aforesaid closed position 10 articles and objects attached to the carabiner frame 270 are held securely within the inner region 290.

The external gate 12 can be moved to an open position 15 by applying an opposing force of sufficient strength to overcome the biasing force 41 that is maintaining the external gate 12 in the closed position 10. Such a force is usually applied with a finger or by pressure applied by an object or article, can be both intentional and unintentional, and will cause the external gate 12 to pivot from the closed position 10 to the open position 15 allowing access to the inner region 290 for the attachment or removal of articles or objects to the carabiner.

Once the applied force is removed the external gate 12 will automatically pivot back to a closed position 10 urged by the biasing force 41.

Reference is also made to FIGS. 2, 2A and 3A to 3F which illustrates the directions of biasing forces acting on a second wire gate 149 pivotably coupled to a carabiner frame 270 with said gate in a closed position 60, when in an open position 65 and when selectably rotated from a closed position 60 to an open position 65 and from an open position 65 to a closed position 60.

In detail, a second wire gate 149 as configured in the gate biasing system described in FIGS. 2, 2A and 3A to 3F, is pivotably coupled to the section of the spine 273 projecting into the inner region 290 substantially in a direction towards the opposing side of the frame 275, 285, 280 with said gate 149 selectably pivotable about the respective pivots 153 and 154 and frame apertures 153a and 154a between a closed position 60 as described in FIG. 4A to an open position 65 as described in FIGS. 4B and 4C, with opposing biasing forces 91, 92 as described in FIGS. 2 and 2A urging said gate 149 to remain in either of two selectably chosen positions 60, 65.

When pivoted to the open position 65 it can be seen in FIGS. 4B and 4C that the free end 152 of the second wire gate 149 is configured to be biased 92 towards and in contact with the spine section 273 of the carabiner frame 270, and will remain in this position 65 unless acted upon by an external force.

It can be seen that the second gate 149 when in the open position 65 is folded in a compact manner against, and remains biased 92 towards, the carabiner frame 270 and does not intrude into, nor interfere with access to, the inner region 290 of the carabiner 271.

It can also be seen that the second gate 149 when in the open position 65 does not interfere with the rotation of the first external gate 12, said gate 12 being freely pivotable from a closed position 10 to an open position 15 as desired.

In particular, FIG. 4B describes the second wire gate 149 in an open position 65 biased 92 against the frame 270 with the first external gate 12 in a closed position 10 in contact with, and biased 41 against the frame end 275, to enclose a continuous inner region 290 with respect to the carabiner frame 270 and the external gate 12.

FIG. 4C illustrates the second wire gate 149 remaining in said open position with the first external gate 12 pivoted to an open position 15 to allow access to the inner region of the carabiner 271.

When desired the first external wire gate 12 can be prevented from moving from a closed position 10 to an open position 15 by selectably rotating the second internal wire gate 149 from the open position 65 to the closed position 60 by applying an opposing force of sufficient strength to overcome the biasing force 92 urging the internal gate 149 to remain in the open position 65 and in contact with the carabiner frame 270. The aforesaid opposing force must be applied until the internal gate end 152 has rotated to a position halfway 101 toward the closed position 60 at which location 101 the biasing forces 92 acting on the internal gate will reverse in direction 91 and urge the gate towards the closed position 60, where said gate 149 will remain until acted on by another force, as additionally described in FIGS. 2 and 2A.

FIG. 4A describes carabiner 271 in a locked state with both the external gate 12 and the internal gate 149 in closed positions 10, 60. The closed position 10, 60 of both gates 12, 149 are configured so that the gate arms 150, 151 of the internal gate 149 lie in a generally perpendicular orientation 295 to the external gate 12, with said gate 149 blocking the external gate 12 from rotating from a closed 10 to an open position 15.

In particular, in one embodiment, the gate biasing mechanism would be configured so that when the internal gate 149 is in the closed position 60, the lengthwise orientation of the internal gate 149 would lie in a generally perpendicular orientation 295 to the external gate 12 and the loop end of the internal gate 152 would be in contact or in close proximity to the external gate 12, with such contact placing no force on said gate 12. Any force applied to rotate the external gate 12 from a closed position 10 to an open position 15 would be blocked by the internal gate 149 as the external gate 12 came into contact with the end 152 of the internal gate 149, with said applied rotational force being re-directed through the contact with gate 149 along the length of the external gate 149 through the pivot coupling 154, 154a, 153, 153a and applied against the carabiner frame 273. Such a dissipation of the applied force would prevent the rotation of the internal gate 149 which would remain in the closed position 60, and continue to block the external gate 12 from moving to an open position 15.

In another embodiment the gate biasing mechanism would be configured so that when the internal gate 149 is selectably moved from the open 65 to the closed position 60, the loop end 152 of the said gate 149 rotates past, and stops at a point past a perpendicular orientation 295 to the external gate 12. In such an orientation, any force applied by the external gate 12 would be transferred to the blocking internal gate 149 at the contact point 152 in a direction opposite to the closest circumferential path to the open position 65 of said gate 149, such rotation being automatically resisted by torsional biasing forces 97 as illustrated in FIG. 2 thereby blocking the rotation of the external gate 12 to an open position 15, securing said gate 12 in a closed position 10.

As illustrated in FIG. 2 the strength of the opposing biasing force 97 can be determined by the configuration of the gate biasing system and increased or decreased as desired.

It will be evident that the location of the loop end 152 of the internal gate 149 to be at or above a perpendicular orientation 295 to the external gate 12 when in a closed position 60 could be configured to be positioned at any point along the length of said external gate 12 and at all such locations the external gate 12 would be secured from rotating to an open position 15.

In the preferred embodiment as described in FIG. 4A the gate biasing mechanism is configured so that the internal gate 149 in the closed position 60, is rotated past a perpendicular orientation 295 to the external gate 12 as the internal gate 149 is rotated from the open position 65 to the closed position 60. In the closed position 60 the loop end 152 of the internal gate 152 will be in contact or in close proximity to the external gate 12, with such contact placing no force on said gate 12. Further, the loop end 152 of the external gate 149 would be positioned below an internally projecting section 300 of the carabiner frame end 275 such that any force applied to move the external gate 12 from a closed 10 to an open position 15 would be transferred to the internal gate 149 at the contact point 152 causing said gate 149 to rotate in a direction opposite to the open position 65, with such rotation blocked by the projecting section 300 of the carabiner frame 270, in turn blocking gate 12 from rotation and securing said gate 12 in the closed position 10.

The external gate 12 will be secured and locked in the closed position 10 until the internal gate 149 is selectably rotated to an open position 65 to allow the external gate 12 to also be rotated to an open position 15 as described in FIGS. 4B and 4C.

It can be seen that when the internal gate 149 is in a closed position 60 the inner continuous region 290 is divided into two portions 290a and 290b with each separate portion 290, 290a able to contain separately attached articles, said articles remaining securely attached to the carabiner 271 and prevented from interacting with the other until the internal gate 149 is moved to an open position 65.

Although the first external gate 12 is shown as a wire gate in FIGS. 4A to C, the gate can include any other suitable type of carabiner gate that allows it to selectably open and close the gap between the frame’s first and second ends. In this regard, some examples of suitable gates include any suitable solid gate, spring gate, wire gate, bent gate, and / or any other suitable type of carabiner gate.

While the internal gate has been described as being pivotably attached to a thickened portion of a carabiner frame, said gate can be disposed in any suitable location on the frame that allows the gate to selectably rotate between an open and closed position. In some implementations the described gate is attached to another portion of the frame. Indeed, in some implementations, the gate is pivotably attached to: one or more spine portions of the frame, a gate support member extending from the frame, a thickened portion of the frame, and/or any other suitable portion of the frame. In some implementations, the gate is pivotably (e.g., pivotally, rotatably, bendably, resiliently, etc.) attached to a gate support member that extends from the frame’s spine into the internal space defined by the frame. In some implementations the gate is pivotably attached so as to extend from the frame’s spine into the internal space defined by the frame while in other implementations the gate is pivotably attached so as to extend from the frame’s spine outside of any internal space defined by the frame.

The references to an external gate and an internal gate are relative to the embodiment described in FIGS. 4A to 4B and are not intended to be defining. More specifically, in a different embodiment the gate 149 referred to as an internal gate could be positioned on an external portion of a frame and the gate 12 referred to as external gate could be position on an internal portion of the frame.

Unless defined otherwise, all technical and scientific terms used herein have the same meaning as commonly understood by one of ordinary skill in the art to which these inventions belong.

It should be noted that various alternative carabiner or attachment designs may be practiced in accordance with the present invention, including one or more portions or concepts of the embodiment illustrated in FIG. 4A or described above.

It is to be understood that, even though characteristics and advantages of various embodiments of the present invention have been set forth in the foregoing description, together with details of the structure and function of various embodiments of the invention, this disclosure is illustrative only, and changes may be made in detail, especially in matters of shape, size and arrangement of parts, within the broad principles of the present invention, to the full extent indicated by the broad general meaning of the terms in which the appended claims are expressed. Rather, all suitable modifications and equivalents may be resorted to, falling within the scope of the invention.

For example, the present invention can be applied to a frame of any suitable shape and any suitable material, and can be of a more complex form having projections extending into the internal space within the frame and with such projections sometimes separating the frame into two or more inner regions with two or more gaps.

What is claimed is:

1. A carabiner system comprising:
a frame having a first end and a second end, wherein the frame extends between, and defines a gap between, the first end and the second end, and wherein the frame is shaped to define an internal space; and
a spring wire gate pivotably coupled to the frame, wherein the inherent torsional rigidity of the gate generates a rebound or spring response force which resists distortion of the gate structure, said force automatically biasing the gate back toward a configuration of least distortion, with the spring wire gate configured to be pivotably rotatable between two selectable positions, wherein both positions the wire gate is undistorted, automatically remaining in either selected position; and
the biasing force resisting movement of the gate from either position to the other position reverses in direction towards the other position at a point substantially midway between the two positions.

2. The carabiner system of claim 1 wherein the gate is composed of an elastically deformable material.

3. A carabiner, comprising:
a frame having a first end and a second end, wherein the frame extends between, and defines a gap between, the first end and the second end, and wherein the frame is shaped to define an internal space; and
a first gate pivotably coupled to the first end of the frame wherein the gate is configured to selectably move between a first closed position in which the gate comes into contact with the second end of the frame and an open second position in which the gate pivots away from the frame, such that when the gate is in the closed position the carabiner and frame define an inner region, and when the gate is in the open position, an article is able to enter the inner region through the gap; and
wherein the first gate is biased toward the first closed position with the free end in contact with the frame; and
a second spring wire gate pivotably coupled to the frame and moving between two selectable positions both within and orientated to the inner region and which, when in the first of the two selectable positions, blocks the first gate from moving from a closed to an open position and which, when in the second selectable position, does not impede the first gate from moving between a closed and an open position; and
wherein the inherent torsional rigidity of the second gate generates a rebound or spring response force which resists distortion of the gate structure, said force automatically biasing the second gate back toward a configuration of least distortion, with the second gate configured to be pivotably rotatable between two selectable positions, wherein both positions the second gate is undistorted, automatically remaining in either position once selected; and
when in the first position, the end of the second gate is biased to remain immediately adjacent and substantially perpendicular to the first gate, dividing the inner region into two portions substantially discontinuous to the other and preventing the first gate from opening; and
when in the second position, the end of the second wire gate is biased away from the first gate in a direction towards and substantially in contact with the frame, no longer dividing the inner region into two portions and allowing the first gate unimpeded movement between a closed and an open position.

4. The carabiner of claim 3 in which the end of the second gate, when in the first position is adjacent to but past a perpendicular orientation to the first gate relative to the shortest distance to the second position.

5. The carabiner of claim 3 in which the end of the second gate, when in the first position is adjacent to but past a perpendicular orientation to the first gate relative to the shortest distance to the second position; and
wherein a section of the frame projects into the inner region so that, when the second wire gate is in the first position, the projection blocks the second gate moving away from the second position if the first gate is pushed against the second gate.

6. The carabiner of claim 3 wherein the second gate is composed of an elastically deformable material.

7. The carabiner of claim 3 in which the end of the second gate, when in the first position is adjacent to but past a perpendicular orientation to the first gate relative to the shortest distance to the second position; and
wherein the second gate is composed of an elastically deformable material.

8. The carabiner of claim 3 in which the end of the second gate, when in the first position is adjacent to but past a perpendicular orientation to the first gate relative to the shortest distance to the second position; and
wherein a section of the frame projects into the inner region so that, when the second wire gate is in the first position, the projection blocks the second gate moving away from the second position if the first gate is pushed against the second gate; and
wherein the second gate is composed of an elastically deformable material.

9. The carabiner of claim 3 wherein the frame is multi-chambered having more than one inner region and more than one first gate and one or more second gates, wherein the first gates allow or block access to the respective inner regions and the second gate/s selectably allow or block the movements of the first gate/s.

10. A carabiner, comprising:
a frame having a first end and a second end, wherein the frame extends between, and defines a gap between, the first end and the second end, and wherein the frame is shaped to define an internal space; and
a spring wire gate pivotably coupled to the first end of the frame wherein the gate is configured to selectably move between a first closed position in which the gate comes into contact with the second end of the frame and an open second position in which the gate pivots away from the frame, such that when the gate is in the closed position the carabiner and frame define an inner region, and when the gate is in the open position, an article is able to enter the inner region through the gap; and
wherein the inherent torsional rigidity of the spring wire gate generates a rebound or spring response force which resists distortion of the gate structure, said force automatically biasing the gate back toward a configuration of least distortion, with the gate configured so that in both selectable positions the gate is undistorted, automatically remaining in either position once selected; and
the biasing force resisting movement of the gate from either position to the other position reverses in direction towards the other position at a point substantially midway between the two positions; and
when in the first position, the gate is biased toward the closed position with the free end in contact with the frame and when in the second position the gate is oriented and biased away from, and external to, the inner region formed with respect to the frame and gate in the first position.

11. The carabiner of claim 10 wherein the gate is composed of an elastically deformable material.
